(19) United States
(12) Patent Application Publication
(10) Pub. No.: US 2015/0088867 A1
(43) Pub. Date: Mar. 26, 2015

(54) System and Method for Enabling Communication Between Users

(71) Applicants: Gregory A. Miller, Santa Rosa, CA (US); Mark Timothy Turnage, Denver, CO (US)

(72) Inventors: Gregory A. Miller, Santa Rosa, CA (US); Mark Timothy Turnage, Denver, CO (US)

(21) Appl. No.: 14/495,761

(22) Filed: Sep. 24, 2014

Related U.S. Application Data
(60) Provisional application No. 61/882,989, filed on Sep. 26, 2013.

(51) Int. Cl. G06F 17/30; H04L 29/08

(52) U.S. Cl. CPC G06F 17/30864; H04L 67/10
USPC 707/722

(57) ABSTRACT

A system and method are provided for enabling communication between users. The system comprises a communication system made up of a plurality of users, each user provided with a communication device, and a network server configured with a searchable personal information database, a database searching algorithm, and a communication link with each user's communication device. Users transmit location and personal information from said communication devices to the network server, where it is stored in a personal information database. A user may initiate a search by transmitting search parameters to the network server; the server performs the search and transmits the results back to the first user. The results are displayed on the first user's communication device such that each search result is graphically arranged according to the location of the user corresponding to the search result. A method of graphically displaying a person's personal information is also disclosed.

### CROSS-REFERENCE TO RELATED APPLICATION

This patent application claims the priority benefit under 35 U.S.C. §119(e) of U.S. Provisional Application No. 61/882,989, filed on Sep. 26, 2013, which is incorporated by reference as if fully set forth herein.

### BACKGROUND

1. Field

The present disclosure relates generally to a system and method for enabling communication between users. More particularly, in several embodiments the disclosure relates to a method of locating users based on their location, identifying such users, displaying located users graphically, and enabling communication and other services between such users.

It also relates to a system implementing such a method, and to a method for graphically displaying a person's personal information.

2. Description of Related Art

Systems are known which match users with each other based on the users' characteristics, preferences and location. For example, U.S. Pat. No. 8,295,851 to Finnegan et al. describes a system and method of interactive and live computerized matching in which a user is provided with a personal data device having the ability to communicate wirelessly. The user transmits his personal characteristics and those of his ideal match to a database server, which compares the search criteria to the personal characteristics of other users. The server then notifies the user of those other users who are in the same location and whose characteristics match the user's search criteria.

U.S. Pat. No. 8,023,929 to Mgrdechian et al. describes a communication system comprising wireless devices configured to query each other and a remote computer device configured to store and serve user profiles to the wireless devices. Users can view the profiles of other users, identify friends or colleagues they have in common with other users and send messages to each other.

However, such systems have drawbacks. Although prior art systems may supply a user with a list of others who are located within a predetermined distance from the user, such systems do not provide the others' precise locations. Further, prior art systems are live and do not allow the user to review or communicate with matches after they have moved out of the area or otherwise no longer match.

There is a need for a system that resolves these drawbacks.

### SUMMARY OF THE INVENTION

This need and others are met by embodiments of the invention, which are directed towards a method for enabling communication between users comprising: providing a communication system comprising a plurality of users, each user provided with a communication device; and a network server configured with a searchable personal information database, a database searching algorithm, and a communication link with each user's communication device; allowing the users to transmit location and personal information from said communication devices to the network server; storing the transmitted location and personal information in the personal information database; allowing a first user to transmit search parameters from his communication device to the network server; allowing the first user to initiate a search of the personal information database by instructing the database searching algorithm to search for and identify search results comprising other users whose location and personal information correspond to the search parameters transmitted by the first user; allowing the network server to transmit the search results to the first user; and displaying the search results on the first user's communication device, wherein each search result is graphically arranged according to the location of the user corresponding to the search result.

By graphically arranging the search results on the first user's personal data device, the first user can see the location of each search result in relation to other search results, to nearby landmarks and to the scene at hand. Technology exists which can determine the precise location of a personal data device. The present invention collects the location information for the search results and uses it to present the results to the first user in a unique and useful way.

Further embodiments of the invention are directed to a system for enabling communication between users, comprising: a plurality of users, each provided with a communication device configured to transmit location, personal information and search parameters to a network server and to receive and display search results, wherein each search result is displayed graphically according to the location of the user corresponding to the search result; and a network server configured with a searchable personal information database, a database searching algorithm and a communication link to the users' communication devices, and configured to perform actions, including receiving location, personal information and search parameters from users; storing location, personal information and search parameters in the personal information database; allowing a first user to initiate a search of the personal information database by instructing the database searching algorithm to search for and identify search results comprising other users whose location and personal information correspond to the search parameters transmitted by the first user; and transmitting the search results to the first user.

Further embodiments of the invention are directed to a method of graphically displaying a person's personal information, comprising: providing a data device configured with a graphical display and a location graphing algorithm; providing a person's personal information and location data to the data device; providing an image of a real-life area, wherein the person's location is within the real-life area; displaying the image of the real-life area on the graphical display; and instructing the location graphing algorithm to superimpose at least one piece of the person's personal information onto the image of the real-life area, wherein the personal information is displayed according to the person's location.

In a further embodiment, the search results are displayed superimposed over a real-life image.

In a further embodiment, the search results are displayed superimposed over a street map or photographic image.

In a further embodiment, the data device is configured with a camera, and the image of the real-life area is provided by said camera.

In a further embodiment, the first user communicates with the user corresponding with each search result. Such communication may be, for example, via voice, video, electronic mail or text messaging.

In a further embodiment, the users transfer money or data.

In a further embodiment, at least one device is configured with a wireless communication system.

In a further embodiment, one of the first user's search parameters is the maximum distance between the location of the first user and the location of another user.

In a further embodiment, the personal information database stores the results of each database search, so that the first user can review and communicate with the results of prior searches.

It is an object of the invention to provide users with a location-based search-matching system and method which allows the search results to include precise location.

It is an object of the invention to provide users with a location-based search-matching system and method which allows the search results to be graphically arranged and superimposed on a real-life image according to their precise locations.

It is an object of the invention to provide users with a location-based search-matching system and method which allows the search results be graphically arranged and superimposed on a street map or photographic image according to their precise locations.

It is an object of the invention to provide users with a location-based search-matching system and method which allows the search results to be graphically arranged and superimposed on a real-life image according to their precise locations, where the real-life image is provided by a camera fitted to the user's personal data device.

It is an object of the invention to provide users with a location-based search-matching system and method which allows the search results to be stored and acted upon later.

These and other objects of the invention are achieved by the system and methods described herein. Additional features and advantages are described herein, and will be apparent from, the following detailed specification and the figures.

### BRIEF DESCRIPTION OF THE DRAWINGS

A full understanding of the disclosed invention and concept can be gained from the following description of the preferred embodiments when read in conjunction with accompanying drawings in which:

FIG. 1 is a flow chart showing a method of enabling communication between users according to the invention;

FIG. 2 is a schematic view of a system for enabling communication between users according to the invention;

FIG. 3 is a flow chart showing a method of graphically displaying search results according to an embodiment of the invention;

FIG. 4A is a view of an embodiment of the search display according to an embodiment of the invention;

FIG. 4B is a view of an embodiment of the search display according to an embodiment of the invention;

FIG. 4C is a view of an embodiment of the search display according to an embodiment of the invention; and

FIG. 4D is a view of an embodiment of the search display according to an embodiment of the invention.

### DESCRIPTION OF THE PREFERRED EMBODIMENTS

While a specific embodiment of the invention is described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

As employed herein, the term “users” refers to any persons or entities that wish to locate other persons or entities that within a predetermined geographic area. The term “first user” refers to a user that initiates a search.

As employed herein, the term “personal information” refers to information that is linked to a particular user. Such information may include, for example, a user's name or pseudonym, contact information, account number, age, gender, likes, dislikes, etc. Such information may include a photograph or avatar image. A piece of personal information, as the term is employed herein, need not necessarily allow the identification of a particular person. Together, such information is sometimes commonly referred to as a user's “profile.”

As employed herein, the terms “communicate” and “communication” refer broadly to any type or method of transmitting analog or digital data or information from one user or user's device to another user or user's device. Communication may be, for example and without limitation, the transmittal of audio, video, text, an image or a data stream.

As employed herein, the terms “image of a real-life area” and “real-life image” mean a representation of an actual scene, such as a map, illustration, photograph or radiation scan. As employed herein, the terms “photograph” and “photographic image” include electronic images such as those generated by digital cameras, both still and video.

For various reasons, people often wish to communicate with other people unknown to them. They may wish, for example, to connect for the purpose of buying or selling, for finding others of similar interests, for dating, etc.

Disclosed is a system and method for enabling communication between users based on location. Also disclosed is a method for graphically displaying search results.

Users are provided with communication devices, for example personal data devices such as mobile telephones, personal digital assistants or palmtop computing devices. Such devices communicate with a server. The server can store the personal information of users in a database, can search the database according to given search parameters, and can transmit search results back to users who request a search. Search results may be graphically displayed on a user's communication device, with the results arranged according to the location of the corresponding person. The server may also act as a communications switch, connecting any two users to each other.

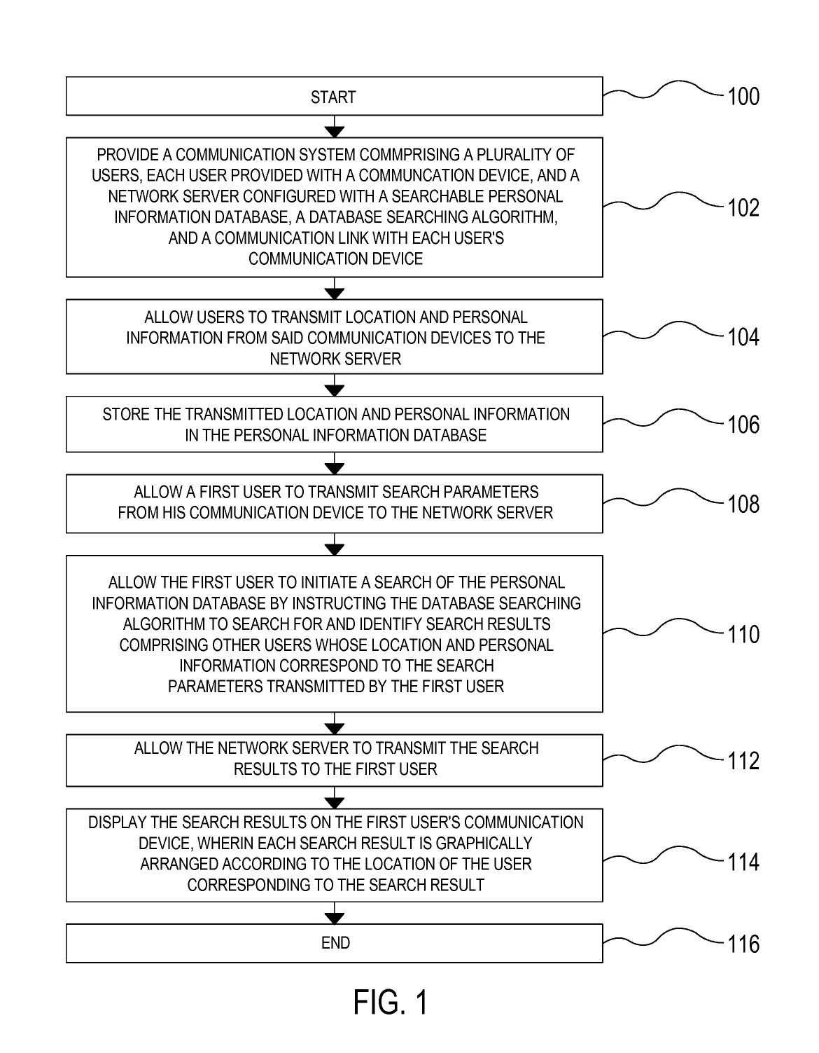

FIG. 1 shows a flow chart of a method for enabling communication between users. The method starts at 100, and at 102, a communication system is provided. The communication system comprises a plurality of users, each provided with a communication device, and a network server configured with a searchable personal information database, a database searching algorithm and a communication link to each user's communication device.

Any type of communication device may be employed, but in a preferred embodiment, a user's communication device is a personal data device such as, for example and without limitation, a mobile or cell phone, a personal digital assistant or a palmtop computing device. The communication device communicates with a network server. In a preferred embodiment, at least one user's device is configured to communicate wirelessly, for example, by way of a wireless internet data connection.

The network server is configured with a database suitable for storing users' personal information and for searching therein, and an algorithm to control and manage the data storage and searching. The server is also configured with a communication link to each user's communication device. In a preferred embodiment, communication is by way of internet data connections. Thus, the server can communicate with each user and can connect each user to any other user.

At 104 users transmit their location and personal information to the server, and at 106 their location and personal information is stored in the personal information database. Information stored for a user may include, for example, the user's user name and device ID, as well as profile information such as the user's age, gender and interests. The information may also include the user's photograph or avatar image. Preferably, users enter their information into the database through their communication devices, or they may enter it directly into the server. Users may also have an editing ability so that they may keep their information current or change it for different purposes.

A user may transmit his location manually, but in a preferred embodiment, the user's personal data device sends the user's location to the server automatically according to a periodic schedule, for example every few seconds. Location can be electronically determined by any of several methods known in the art, such as by GPS or cell tower triangulation. As used herein, the term “location” is used to refer both to the location of a user and to the location of his communication device. Both locations are considered the same and the term is used interchangeably.

At 108 an initiating user (a “first user”) transmits search parameters to the server. The search parameters give the server search algorithm the criteria with which to filter and select the pool of users stored in the database. While not required by the method, storing the search parameters and search metadata in the database may allow for more advanced future searches. Storing the results of the search allows the first user to review and act upon the results at a later time when it may be impossible to reproduce the results by requesting another search. Duplicate results may be impossible because, for example, users have moved outside the search distance, changed their personal info, or exited the method by turning off their devices.

At 110 the first user instructs the server search algorithm to execute a search. The algorithm identifies all other users whose location and personal information match the first user's search parameters by comparing the first user's search parameters with other users' location and personal information stored in the database.

As a search parameter, the first user may specify a particular maximum distance within which search results will be located (for example, within 500 feet of the first user). Other search parameters may relate to any of the kinds of personal information users have stored in the database (for example, users under 30 years of age).

At 112 the server transmits the search results to the first user, and at 114 the first user's communication device displays the search results graphically, so that each result is arranged according to the location of the corresponding user. The search results may be, for example, superimposed over an image of the real-life area surrounding the first user, such as a street map or photograph. In a preferred embodiment, the first user's communication device is configured with a camera, the camera provides a photographic image of the area near the first user, and the search results are superimposed over the photographic image. The method ends at 116.

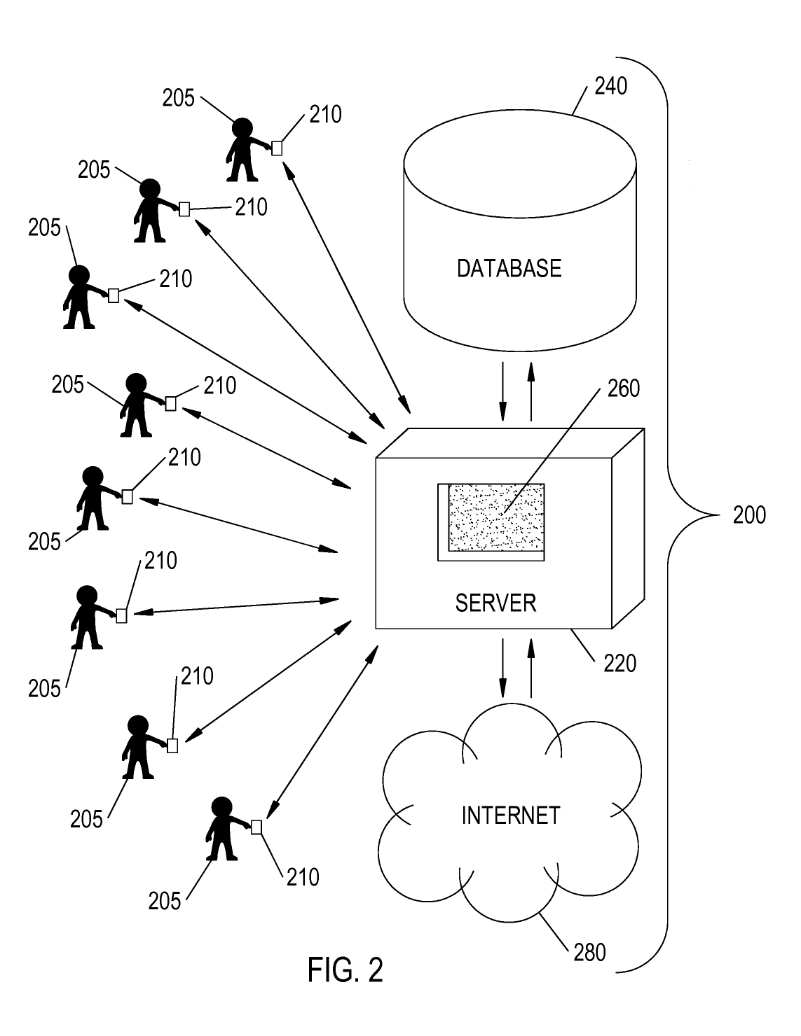

FIG. 2 illustrates a system 200 for enabling communication between each of a plurality of users 205. Although FIG. 2 shows eight users for the sake of simplicity, the actual number of users in the instant system is not limited thereto. One skilled in the art will immediately recognize that the described system will function with any number of users greater than one. Each user 205 is equipped with a corresponding communication device 210. The communication devices may be of any kind of communication device, and the communication method may be of any kind; however the devices are preferably portable electronic personal data devices that communicate with the server 220 wirelessly.

The server 220 is an electronic device configured to communicate with the users' communication devices 210. Communication may be by any available means, for example and without limitation, communication may be via the internet or by radio. Each user 205 inputs his location and personal information into his communication device 210. In a preferred embodiment each user's location is automatically calculated and stored by the communication device itself, for example by means of a GPS or cell tower triangulation method. However derived, each user's location and personal information are transmitted to the server 220 and stored in a database 240. If a user 205 wishes to initiate a search, then the user must also enter and transmit his search parameters.

The server 220 is configured to operate a database 240 for the storage and retrieval of users' locations and personal information. The database 240 comprises one or more data storage devices, such as, for example and without limitation, disk drives, flash drives or solid state memory. The server 220 is configured with a database searching algorithm 260 to effect searches. The server 220 may optionally be additionally configured to communicate with the internet 280 so that various third party internet services, such as payment or file sharing services, may be accessed by users 205.

Any user 205 may initiate a search by transmitting specific search parameters through his communication device 210 to the server 220 and instructing the server 220 to execute the database searching algorithm 260, applying that user's specific search parameters to the location and personal information of all other users that are stored in the database 240.

For example, if a first user initiates the search, then the first user, using his communication device, transmits his search parameters and an instruction to search to the server 220. The server 220, using the database searching algorithm 260, compares the first user's search parameters with the location and personal information of the other users that are stored in the database 240.

At the completion of the search, the server 220 transmits the search results back to the communication device corresponding to the requesting user. Continuing the prior example, if a first user initiates the search, then the server 220 transmits the search results back to the first user's communication device 210. The first user may then elect to communicate with any of the users corresponding to the search results by, for example, sending a text message or opening a voice communication link through the server 220.

The first user may choose to communicate with any or all of the search results. To aid in deciding, the first user's communication device may display the search results graphically according to each result's location. For example, the search results may be superimposed over a real-life image of the first user's area. Such an image may be, for example, a street map, aerial photograph or street view image. Such images may be obtained from an internet source by the first user's communication device 210 through the server 220, or may be obtained by the server 220 and transmitted to the first user's communication device 210 along with the search results. Alternatively and preferably, a photographic image may be obtained from the first user's communication device 210 itself when that device is configured with a camera.

Thus, the first user may activate a camera in his communication device and point it towards a group of other users. If any of the users in view of the camera are included in the search results, an indication to that effect, such as a textual tag, could be superimposed over or near their image. As the camera pans or as other users move in or out of the camera view, tags may appear and disappear as the users they refer to move in and out of the camera view.

The first user may select to communicate instantly with the search result through the server 220. Such communication may be by any available means, for example by audio, video or text message. Direct contact and identification information may be blocked to preserve the users' privacy. Alternatively, the first user may elect to save the search results and contact one or more of them at a future time, even though the search results may no longer meet the user's search parameters at that time.

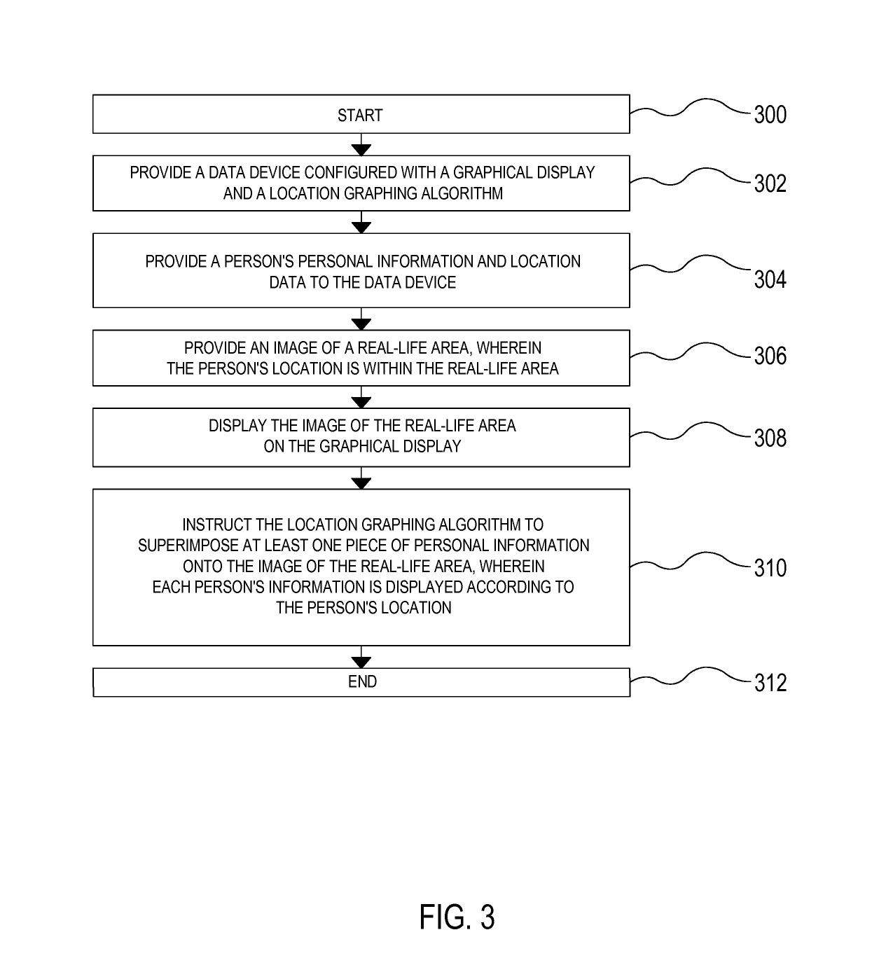

The present invention also provides a method of graphically displaying a person's personal information based on location. FIG. 3 is a flow chart of such a method. The method starts at 300. At 302 is provided a data device configured with a graphical display and a location graphing algorithm. Such device may be, for example and without limitation, a mobile telephone or pager having a graphical display, a smartphone, a personal data device, a computer monitor, cathode ray tube or television monitor.

At 304 personal information and location are provided to the data device. Such personal information may include, for example and without limitation, a person's name or pseudonym, age, gender, likes, dislikes and various descriptive tag words.

At 306 an image of a real-life area is provided to the data device. The real-life image may be from a neutral vantage point, for example from above. In this case the image may be an aerial photograph or street map. The image may also have been previously captured from a vantage point at street level. Such photographs, maps and street view images may be stored locally on the data device or may be obtained via an internet source as needed.

However, in a preferred embodiment, the real-life image may be from the vantage point of the data device itself. The data device may be configured with a camera to capture such images, or a simplified drawn or animated image may be created from the camera image by a graphic drawing algorithm. At 308 the real-life image is displayed on the graphical display.

At 310 the location graphing algorithm is instructed to superimpose at least some of the personal information onto the image of the real-life area. Each person's information is displayed according to the person's location. For example if the data device is provided with the information that the person named JOE is located at the corner of First and Main Streets, then the device may display a street map of the area with an icon or marking at the corner of First and Main labeled JOE. Additional personal information relating to JOE may also be shown, or may be available by selecting, tapping or clicking on the JOE icon. Alternatively, if the data device is within view of the corner of First and Main and it is configured with a camera, then it may display a photographic view of the area taken through the lens of the camera. In this case an icon or marking would appear at JOE's location. If JOE is visible in the image then the icon or marking would appear over or adjacent to JOE's image. JOE may not be visible to the first user's camera because, for example, he is behind an object, behind another person, or inside a building. If JOE is not visible to the first user's camera, then an icon or marking would appear where JOE is estimated to be.

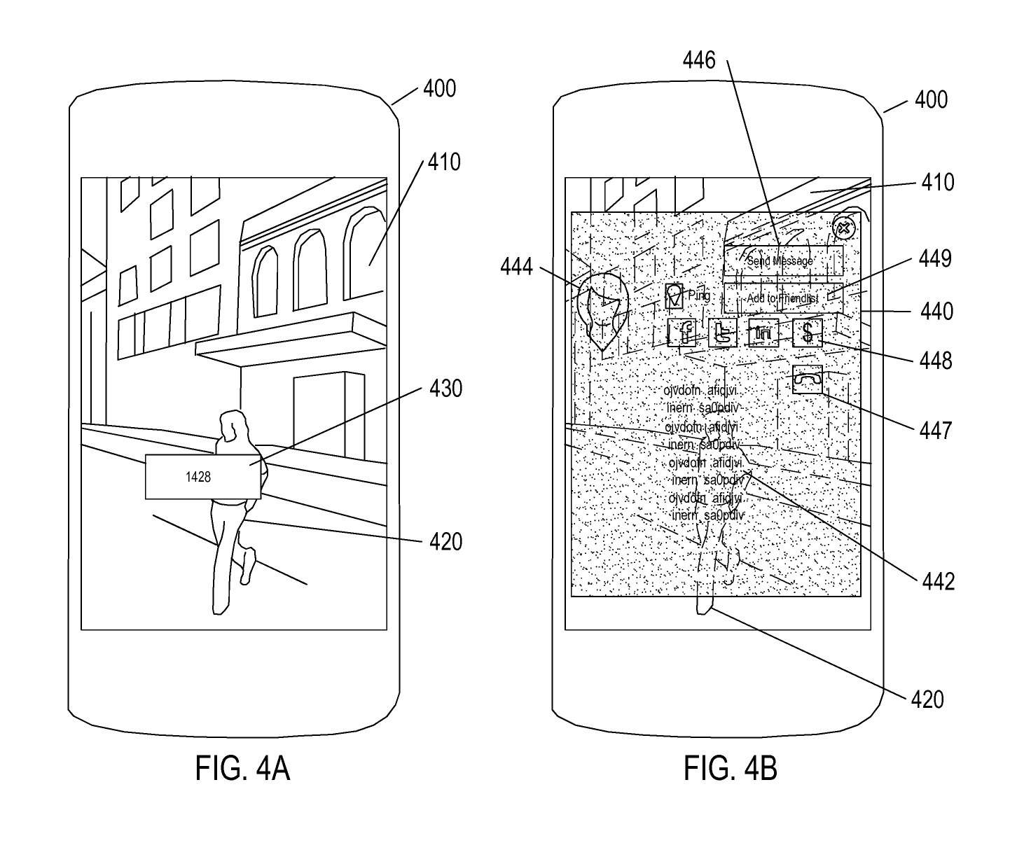

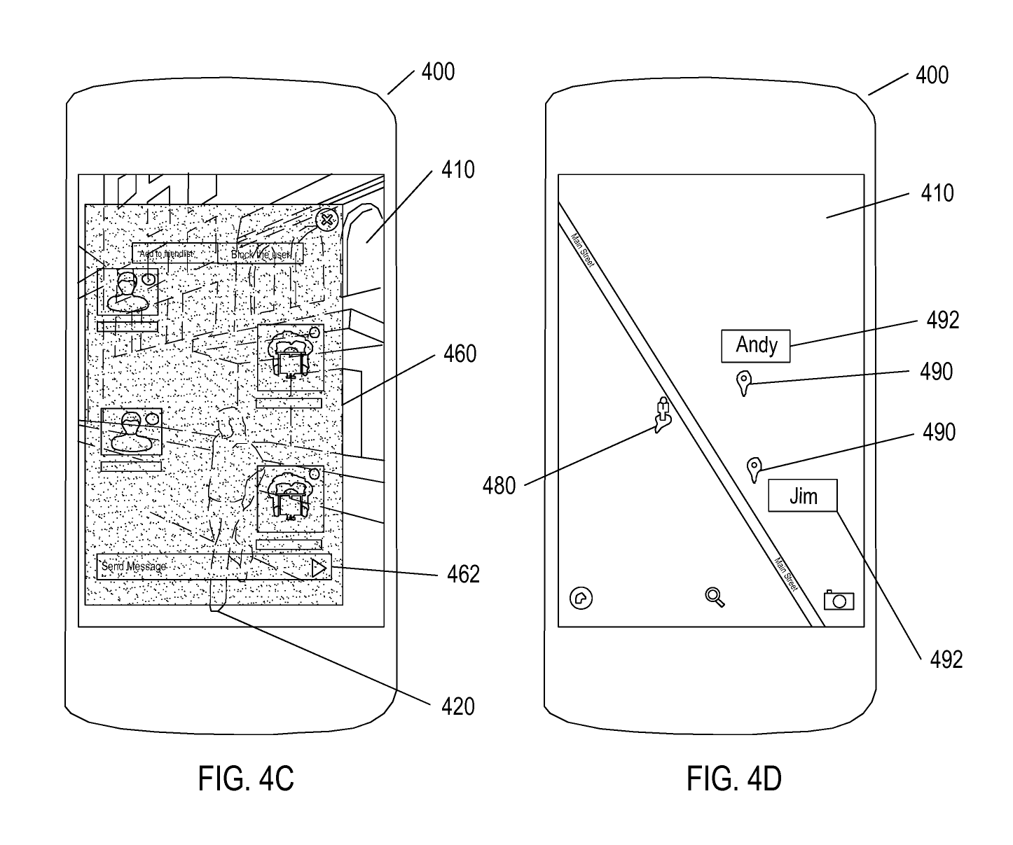

FIG. 4A is an example of a display 410 on a data device 400 (here a smartphone) using the camera view of the device 400 as an image of a real-life area, over which a person's personal information 430 is superimposed according to that person's actual location, using the disclosed method. In this example, the person 420 whose information was provided to the device 400 is visible in the real-life image. The display is real-time and dynamic. As the person 420 exits the camera view, her personal information 430 disappears along with her image. If a new person enters the camera view, and that new person's personal information and location have been provided to the data device 400, then that new person will appear on the display 410 in a similar manner.

In FIG. 4A the personal information 430 comprises only an identifier, in this case the name or pseudonym belonging to the person 420. Such display of limited information may be useful for clarity in situations where there are several identified people in the same real-life image. Additional personal information about the person 420 may be obtained by selecting, tapping or clicking on the identifier 430, which may bring up a display such as the example shown in FIG. 4B. In this example display, a window 440 providing additional personal information 442 is shown on the display 410 of the data device 400. A photograph or avatar 444 of the person 420 may also be shown. The window 440 may also allow the user to take some action with regard to the person 420 selected. For example, the window 440 may comprise buttons to send a message 446, make a telephone call 447, send a payment 448 or add to a friend list 449.

Selecting, tapping or clicking the message button at 446 may open a message window such as that shown in FIG. 4C. The window 460 may comprise a message box 462 for sending text messages to the person 420. The messaging system may be proprietary or it may be an internet-based service.

One skilled in the art will readily recognize that the ability to take additional actions may be included, through both proprietary and internet-based applications available to the public and by subscription. For example, functionality could be included to allow the transfer of money to the person 420 by using, for example, an internet-based payment application. Additional features could be usefully included, for example and without limitation, to allow the two persons to share files and to connect on various social media platforms. Importantly, the method may also allow the user of the data device 400 to record or save the display so that communication, payment, sharing or connection, etc. may be made at a later time when the person 420 is no longer within the user's search range or on the display 410.

FIG. 4D shows an exemplary display using a street map as an image of the real-life area. The data device 400 comprises a display 410 on which is shown a street map of the area surrounding the user of the data device 400. The display 410 indicates the current location of the user with an icon 480, and the location of persons whose personal information was provided with icons at 490. Personal information about such persons 490, for example their names or pseudonyms, are shown at 492. The map view may be zoomable to increase or decrease the size real-life area and correspondingly to increase or decrease the number of persons whose icons 490 are displayed. Selecting, tapping or clicking on the person icons 490 or personal information 492 may open further windows with additional personal information and/or buttons for additional functionality. Such windows (not shown) may be similar to the window and features shown in FIG. 4B.

It will be appreciated by those skilled in the art that changes could be made to the embodiments described above without departing from the broad inventive concept thereof. For example, it is understood that all aspects and embodiments of the present invention can be related to any communication or electronic transfer between two persons, and to any dynamic display of persons or objects. It is understood, therefore, that this invention is not limited to the particular embodiments disclosed, but it is intended to cover modifications that are within the spirit and scope of the invention, as defined by the appended claims.

### Examples Of Use

Following are some examples of practical implementations of the disclosed concept, system and methods.

### Example 1

### A Social Situation

The database is configured to store, as part of each user's profile, information on age, gender, interests and relationship status. User 1 may attend a social function such as a party or a pub, where he does not know anyone. He may wish to meet other users who meet certain criteria based on their age, gender, interests and relationship status. User 1 is carrying a mobile phone equipped with a camera and graphical display. User 1 updates his profile with his preferred search terms and activates a phone application initiating a search. His phone transmits his location and identification to the network server, which compares User 1's location and search parameters to the personal information of all other active users. User 1 points his phone camera at the crowd and the search results are displayed on the phone display as icons or tags next to the active users that are within the camera's range of view. User 1 is intrigued by User 2, and drills down by selecting User 2's icon or tag, revealing additional personal information about User 2. User 1 then sends User 2 a communication request via text message.

### Example 2

### A Commercial Situation

The database is configured to store each user's line of merchandise. User 1 goes to a comic book convention with the intention of purchasing Superman merchandise. User 1 is carrying a mobile phone equipped with a camera and graphical display. She updates her profile to show that she is interested in Superman. In the convention hall, she activates the method, and her phone transmits her location and information to the network server. The server searches the database, and transmits back the location and information of all other active users at the convention who are also interested in Superman. These are shown on her phone display as icons or tags superimposed over a map of the convention floor. While she is reviewing these search results, however, she receives a communication request from User 2. When User 1 activated the method, the network server transmitted her location and information to other users at the convention interested in Superman, including User 2. Thus, User 1 appeared on User 2's display and User 2 made the first contact.

After a busy day at the convention, User 1 retires to her hotel and regrets that because of time constraints she was not able to contact all of the search results the server sent her. Fortunately the server stored her search results. She is now able to review the results from the entire day, and she decides to contact User 3, who has gone home from the convention and is now 50 miles away. User 1 telephones User 3 and they arrange to meet the next morning.

### Example 3

### Advertising a Business

User 1 operates a coffee shop in a tourist area that is heavily trafficked with pedestrians. User 1's business (coffee shop) is recorded in his user profile in the database. User 1 wishes to attract tourists to his business. He activates the method using a personal computer behind the counter. His PC transmits his location (which never changes) to the network server, which in turn transmits his location and information to all other active users whose search parameters include User 1's location and business type (coffee shop). User 2 is a tourist from out of town and is not familiar with the location of coffee shops. User 2 configures her profile to include coffee shops in the search results, and activates the method using her mobile phone. The server searches the database and transmits the location of all coffee shops within her search range. User 2 holds up her mobile phone camera, and software running on User 2's phone displays an icon or tag next to the image of User 1's coffee shop in the camera view, conveniently located only 100 feet ahead of her current location. User 2 does not send a communication request, but, directed by her phone display, simply walks over to User 1's business and orders at the counter.

### Example 4

### Order Fulfillment

User 1 is at a baseball game with his six-year-old son; he wishes to purchase a bag of peanuts without leaving his seat in the stands. He configures his profile to include peanut vendors and activates the method using his mobile phone. His phone transmits his location to the network server, which searches the database and transmits back to User 1 the location and other information of other active users who are peanut vendors and who are within User 1's search range. User 2 is a particular peanut vendor working at the game. User 1 selects User 2 from those presented on his phone's display, and sends User 2 a text message ordering peanuts. User 2 notes User 1's location and information, confirms the order by return text message and asks for payment. User 1 sends the requested $8 to User 2 using an internet-based payment service implemented through the network server. Three minutes later the peanuts are delivered to User 1's precise location.

What is claimed is:

1. A method for enabling communication between users comprising:
providing a communication system comprising:
a plurality of users, each user provided with a communication device; and
a network server configured with a searchable personal information database, a database searching algorithm, and a communication link with each user's communication device;
allowing the users to transmit location and personal information from said communication devices to the network server;
storing the transmitted location and personal information in the personal information database;
allowing a first user to transmit search parameters from his communication device to the network server;
allowing the first user to initiate a search of the personal information database by instructing the database searching algorithm to search for and identify search results comprising other users whose location and personal information correspond to the search parameters transmitted by the first user;
allowing the network server to transmit the search results to the first user; and
displaying the search results on the first user's communication device, wherein each search result is graphically arranged according to the location of the user corresponding to the search result.

2. The method of claim 1 further comprising allowing the first user to communicate with the user corresponding to each search result.

3. The method of claim 2 wherein such communication is via audio, video, electronic mail, text messaging or data transfer.

4. The method of claim 2 wherein such communication includes the transfer of money.

5. The method of claim 1 wherein the communication device of at least one user comprises a wireless communication system.

6. The method of claim 1 wherein the search results are displayed superimposed on an image of a real-life area.

7. The method of claim 1 wherein the search results are displayed superimposed on a photographic image.

8. The method of claim 7 wherein the first user's communication device comprises a camera and the photographic image is provided by said camera.

9. The method of claim 1 wherein the first user's search parameters comprise the maximum distance between the location of the first user and the location of another user to be matched.

10. The method of claim 1 wherein the personal information database stores the results of each database search so that search results may be reviewed and acted upon at a later time when the search results cannot be obtained by requesting another search.

11. A system for enabling communication between users, comprising:
a plurality of users, each provided with a communication device configured to transmit location, personal information and search parameters to a network server and to receive and display search results, wherein each search result is displayed graphically according to the location of the user corresponding to the search result; and
a network server configured with a searchable personal information database, a database searching algorithm and a communication link to the users' communication devices, and configured to perform actions, including:
receiving location, personal information and search parameters from users;
storing location, personal information and search parameters in the personal information database;
allowing a first user to initiate a search of the personal information database by instructing the database searching algorithm to search for and identify search results comprising other users whose location and personal information correspond to the search parameters transmitted by the first user; and
transmitting the search results to the first user.

12. The system of claim 11, further comprising a communication system configured to allow users to communicate with each other through their communication devices and the network server.

13. The system of claim 12, wherein such communication is audio, video, electronic mail, text, an image or a data stream.

14. The system of claim 11, further comprising the network server storing the results of each database search so that the search results may be reviewed and acted upon at a later time when the search results cannot be obtained by requesting another search.

15. The system of claim 11, wherein at least one of the communication devices is configured to communicate wirelessly.

16. The system of claim 11, wherein the search results are displayed on the first user's communication device superimposed on an image of a real-life area.

17. The system of claim 11, wherein the search results are displayed on the first user's communication device superimposed on a photographic image.

18. The system of claim 17 wherein the first user's communication device comprises a camera and the photographic image is provided by said camera.

19. A method of graphically displaying a person's personal information, comprising:
providing a data device configured with a graphical display and a location graphing algorithm;
providing a person's personal information and location data to the data device;
providing an image of a real-life area, wherein the person's location is within the real-life area;
displaying the image of the real-life area on the graphical display; and
instructing the location graphing algorithm to superimpose at least one piece of the person's personal information onto the image of the real-life area, wherein the personal information is displayed according to the person's location.

20. The method of claim 19, wherein the data device is further configured with a camera, and the image of the real-life area is provided by said camera.
